(19) United States
(12) Patent Application Publication
(10) Pub. No.: US 2006/0047944 A1
(43) Pub. Date: Mar. 2, 2006

(54) Secure booting of a computing device

(76) Inventor: Roger Kilian-Kehr, Darmstadt (DE)

Correspondence Address: FISH & RICHARDSON, P.C., PO BOX 1022, MINNEAPOLIS, MN, 55440-1022, US

(21) Appl. No.: 10/932,501

(22) Filed: Sep. 1, 2004

(51) Int. Cl. G06F 9/24

(52) U.S. Cl. 713/2

(57) ABSTRACT

Systems, methods, and computer program products implementing techniques for secure booting of a computing device. In one aspect, the techniques include verifying the trustworthiness of the target computing system and only after the trustworthiness of the target computing system has been verified, loading user data onto the target computing system. Verifying the trustworthiness of the target computing system includes establishing communication between the target computing system and a third party system, proving the trustworthiness of the target computing system to the third party system, receiving a decryption key from the third party system once the trustworthiness of the target computing system has been verified by the third party system, and using the decryption key to decrypt user data, the user data being stored in the boot device or at another location accessible to the target computing system.

### BACKGROUND

Today, users carry around portable computers in order to be able to work in remote locations, for example, on the train, in an airport lounge, and so on. In some cases, these locations may have computing terminals available for use by the users. However, users may still choose not to use the available computing terminals due to security concerns. For example, they may be concerned that the computing terminal may copy or tamper with their data.

### SUMMARY

Systems, methods, and computer program products implementing techniques for secure booting of a computing device.

In one aspect, the techniques include verifying the trustworthiness of the target computing system and only after the trustworthiness of the target computing system has been verified, loading user data onto the target computing system. Verifying the trustworthiness of the target computing system includes establishing communication between the target computing system and a third party system, proving the trustworthiness of the target computing system to the third party system, receiving a decryption key from the third party system once the trustworthiness of the target computing system has been verified by the third party system, and using the decryption key to decrypt user data, the user data being stored in the boot device or at another location accessible to the target computing system.

Implementations can include one or more of the following features:

Proving the trustworthiness of the target computing system to the third party system includes performing a remote attestation process.

Performing a remote attestation process includes generating a footprint of the target computing system; and sending the footprint to the third party system.

The target computing system is a TCPA (Trusted Computing Platform Alliance)—enabled system. The target computing system is a TCPA (Trusted Computing Platform Alliance)—enabled system and performing a remote attestation process includes using TCPA commands to perform the remote attestation process.

The boot device is a removable storage device. The removable storage device is a USB device, a compact flash device, a FireWire device, or a smart card device.

The user data includes executable code for an operating system. The user data includes executable code for one or more applications.

In another aspect, the systems include a target computing system, a boot device that is connectable to the target computing system; and a third party system that is separate from the target computing system and the boot device. The boot device includes code executable on the target computing system, the code comprising instructions for booting the target computing system using a two-stage booting process that involves first using the third party system to verify the trustworthiness of the target computing system and only after the trustworthiness of the target computing system has been verified by the trusted third party system, loading user data onto the target computing system. Verifying the trustworthiness of the target computing system includes establishing communication between the target computing system and a third party system, proving the trustworthiness of the target computing system to the third party system, receiving a decryption key from the third party system once the trustworthiness of the target computing system has been verified by the third party system, and using the decryption key to decrypt user data, the user data being stored in the boot device or at another location accessible to the target computing system.

Implementations can include one or more of the following features. The target computing system includes a Trusted Platform Module that provides a set of TCPA (Trusted Computing Platform Alliance) commands and a set of registers for storing a system footprint of the target computing system; and proving the trustworthiness of the target computing system to the third party system includes sending the stored system footprint to the third party system using one or more of the TCPA commands.

The boot device is a removable storage device. The removable storage device is a USB device, a compact flash device, a FireWire device, or a smart card device.

The user data includes executable code for an operating system. The user data includes executable code for one or more applications.

Implementations can realize one or more of the following advantages.

Users no longer need to carry around bulky portable computing devices in order to work in remote locations securely. Instead, users can store their preferred operating system and applications in a small storage device (e.g., a USB memory stick) and use a secure boot process to load the operating system and applications into the computing terminals at the remote locations. The secure boot process ensures that the computing terminals are running in a trusted state before the user's data is loaded onto the computing terminals.

More generally, users can verify the trustworthiness of any computing system, be it a computing system at a remote or public location or a computing system at the user's typical workplace (e.g., within a corporate or private site). In this manner, the general level of security is increased.

The details of one or more implementations are set forth in the accompanying drawings and the description below. Other features and advantages will be apparent from the description and drawings, and from the claims.

### DESCRIPTION OF DRAWINGS

FIG. 1 is a diagram of a target system and a boot device.

FIG. 2 is a diagram of a two-stage booting process.

FIG. 3 is a diagram of a TCPA-based implementation.

FIG. 4 is a diagram of protocol flow within the TCPA-based implementation.

Like reference symbols in the various drawings indicate like elements.

### DETAILED DESCRIPTION

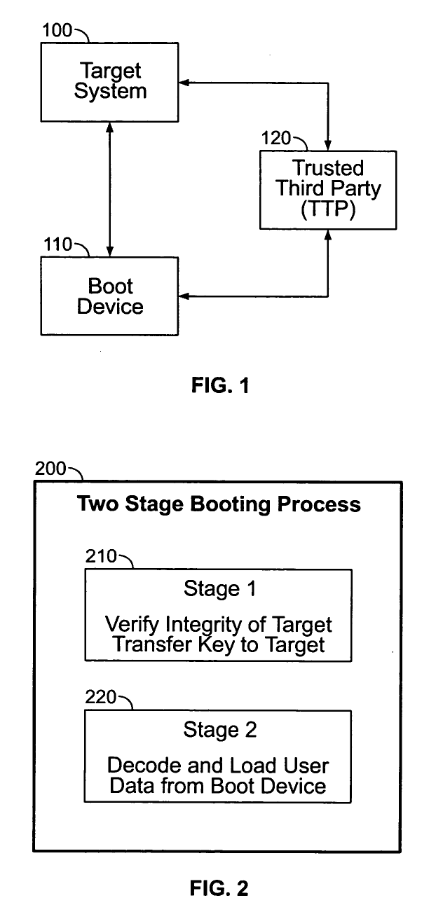

The described implementations provide methods, systems, and computer program products, for secure booting of a computing system (target system) 100 from a boot device 110 (FIG. 1). As will be discussed in more detail below, the secure booting process involves a third party system 120 that is trusted by the user of the target system 100. Such a third party system will be referred to as a trusted third party.

The boot device 110 is a removable storage device that is connectable to the target system 100. The boot device 110 can be a USB (universal serial bus) storage device, a compact flash device, a FireWire device, a smart card, or any other kind of removable storage device that a computer can boot from. The boot device 110 stores data to be used by a user of the target system 100. For example, this data can include executable code for one or more operating systems and applications. Some or all of this data can be stored in a protected form (e.g., encrypted). This data will be referred to as the user data.

The target system 100 can be a personal computer (PC), a workstation, or any other computing device, or cluster of computing devices. In one scenario, the user desires to install the user data onto the target system 100, but only after a trustworthy state has been established on the target system.

Such a trustworthy state can be established using a two-stage boot process 200 shown in FIG. 2. The first stage 210 involves a verification process where the target system proves its trustworthiness to the trusted third party 120. The trusted third party 120 has information about the boot device 110. For example, if the user data contained on the boot device is encrypted, the trusted third party has the decryption key to the user data. During the first stage of the boot process, the trusted third party 120 verifies the trustworthiness of the target system 100, and upon successful verification, it transfers the decryption key to the target system 100.

During the second stage 220 of the boot process, the target system 100 decodes the user data using the decryption key and loads the user data.

In one implementation, the code that initiates and performs the first stage of the boot process is stored on the boot device 110. This code will be referred to as the boot code. The boot code includes code that establishes rudimentary operating system capabilities on the target system 100. These capabilities include the networking capabilities necessary for the target system 100 to establish communication with the trusted third party 120.

In one implementation, the boot code and the user data are stored in separate partitions of the boot device 110. Alternatively, they can be stored in different file directories within the same partition.

In an alternative implementation, the user data is stored in a location remote from the boot device 110 and the target system 100, but accessible to the target system. In other words, the boot device only contains the code to perform the first stage of the boot process. Once the first stage is complete, the code to perform the second stage is read from the remote location. This implementation eliminates the need to carry the user data in the boot device 110. Instead, the user data can be downloaded from the remote location once the first stage boot process 210 is complete.

The following paragraphs describe a TCPA implementation of the verification process and key transfer process. TCPA (Trusted Computing Platform Alliance) is an initiative led by various computing companies (e.g., Advanced Micro Devices, Hewlett-Packard, Intel, IBM, Microsoft, Sony, Sun) to implement technologies for trusted computing. This group of companies, also known as the Trusted Computing Group has published a TCPA specification (available at www.trustedcomputinggroup.org) that describes the TCPA technologies developed by this group. One of the technologies is a chip that can be installed on a computing system to provide the computing system with some trusted computing functionality. This chip is commonly referred to as a trusted platform module (TPM).

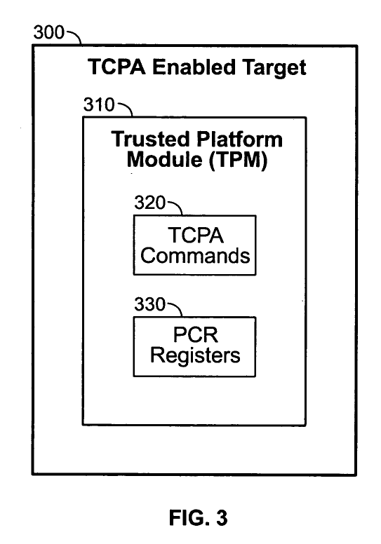

In this implementation, as shown in FIG. 3, the target system 100 is a TCPA—enabled system 300. The TCPA—enabled system 300 includes a trusted computing module 310. The trusted computing module 310 provides a set of TCPA commands 320. These commands 320 include, but are not limited to, commands that can be used by the system 300 to perform the verification process and key transfer process. For example, the following is a list of TCPA commands that the trusted computing module 310 can provide:

| TCPA COMMANDS | FUNCTION |
|---|---|
| authorize | establishes session with TPM |
| load identity | loads identity key into TPM |
| quote | request signed metrics from TPM |
| create key | creates transport key |
| load key | loads transport key into TPM |
| get signed public key | retrieves public part of transport key from TPM |
| unbind | decrypts data using private part of transport key |

These commands will be described in more detail below. The trusted platform module 310 also includes a set of platform configuration registers 330 that are used to store system configuration data.

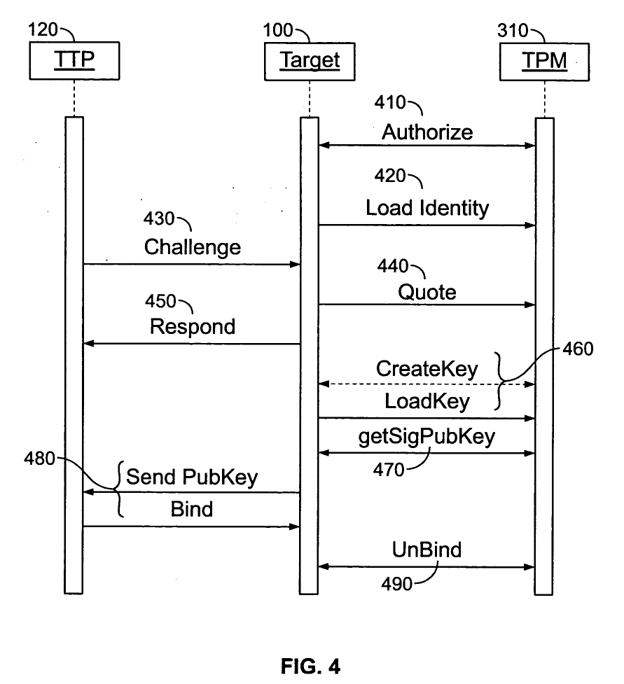

During system operation, as shown in FIG. 4, the system 300 uses the authorize command to establish an authorization session with the trusted computing module 310 (step 410). An authorization session is required in order to execute further commands using the trusted computing module 310.

The system 300 then uses the load identity command to load an identity key into the trusted platform module 310 (step 420). The identity key will be described in more detail below.

As part of a remote attestation process, the system 300 receives a challenge from the trusted third party (step 430). Remote attestation is a process by which a system can prove to a remote challenger that the system is trustworthy (i.e., that its components have not been tampered with).

In response to the challenge, the system 300 uses the quote command to request that the trusted platform module 310 generate a system footprint (step 440). In one implementation, the system footprint is a collection of metrics taken from various hardware components of the system. The metrics are a reflection of how these system components are configured. If the configuration is tampered with or otherwise modified, the metrics will reflect this change. In one implementation, the trusted platform module 310 collects the metrics and stores them in the set of platform configuration registers 330. The trusted platform module 310 then signs (i.e., encrypts) the metrics using the identity key and provides the signed metrics to the system 300.

The system 300 responds to the challenge by sending the signed metrics to the trusted third party (step 450). The trusted third party verifies the validity of the metrics. This verification can be done a variety of ways. For example, the trusted third party can compare the metrics against a set of known system configurations. Assuming the verification is successful, the trusted third party is ready to deliver the decryption key for the user data to the system 300.

In preparation for receiving the decryption key, the system 300 creates a transport key using the create key command and loads the transport key into the trusted platform module 310 using the load key command (step 460).

The transport key includes a public part and a private part. The system 300 retrieves the public part of the transport key from the trusted platform module 310 using the get signed public key command and sends the public part of the transport key to the trusted third party (step 470).

The trusted third party binds or encrypts the decryption key using the public part of the transport key (step 480) and sends the encrypted decryption key to the system 300. The system 300 decrypts or unbinds the decryption key using the unbind command (step 490). The unbind command uses the private part of the transport key to perform the decryption.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described herein, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component (e.g., a data server), a middleware component (e.g., an application server), or a front-end component (e.g., a client computer having a graphical user interface or a Web browser through which a user can interact with an implementation of the invention), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations of the invention have been described. Nevertheless, it will be understood that various modifications may be made. Accordingly, other implementations are within the scope of the following claims.

What is claimed is:

1. A computer program product, tangibly embodied in an information carrier, for booting a target computing system from a boot device connected to the target computing system, the computer program product being operable to cause data processing apparatus to perform operations comprising:
verifying the trustworthiness of the target computing system; and
only after the trustworthiness of the target computing system has been verified, loading user data onto the target computing system, wherein verifying the trustworthiness of the target computing system includes:
establishing communication between the target computing system and a third party system;
proving the trustworthiness of the target computing system to the third party system;
receiving a decryption key from the third party system once the trustworthiness of the target computing system has been verified by the third party system; and
using the decryption key to decrypt user data, the user data being stored in the boot device or at another location accessible to the target computing system.

2. The product of claim 1, wherein proving the trustworthiness of the target computing system to the third party system includes performing a remote attestation process.

3. The product of claim 2, wherein performing a remote attestation process includes:
generating a footprint of the target computing system; and
sending the footprint to the third party system.

4. The product of claim 1, wherein the target computing system is a TCPA (Trusted Computing Platform Alliance)—enabled system.

5. The product of claim 2, wherein the target computing system is a TCPA (Trusted Computing Platform Alliance)—enabled system and performing a remote attestation process includes using TCPA commands to perform the remote attestation process.

6. The product of claim 1, wherein the boot device is a removable storage device.

7. The product of claim 6, wherein the removable storage device is a USB device, a compact flash device, a FireWire device, or a smart card device.

8. The product of claim 1, wherein the user data includes executable code for an operating system.

9. The product of claim 1, wherein the user data includes executable code for one or more applications.

10. A system comprising:
a target computing system;
a boot device that is connectable to the target computing system; and
a third party system that is separate from the target computing system and the boot device,
wherein:
the boot device includes code executable on the target computing system, the code comprising instructions for booting the target computing system using a two-stage booting process that involves first using the third party system to verify the trustworthiness of the target computing system and only after the trustworthiness of the target computing system has been verified by the trusted third party system, loading user data onto the target computing system, wherein verifying the trustworthiness of the target computing system includes:
establishing communication between the target computing system and a third party system;
proving the trustworthiness of the target computing system to the third party system;
receiving a decryption key from the third party system once the trustworthiness of the target computing system has been verified by the third party system; and
using the decryption key to decrypt user data, the user data being stored in the boot device or at another location accessible to the target computing system.

11. The system of claim 10, wherein:
the target computing system includes a Trusted Platform Module that provides a set of TCPA (Trusted Computing Platform Alliance) commands and a set of registers for storing a system footprint of the target computing system; and
proving the trustworthiness of the target computing system to the third party system includes sending the stored system footprint to the third party system using one or more of the TCPA commands.

12. The system of claim 10, wherein the boot device is a removable storage device.

13. The system of claim 12, wherein the removable storage device is a USB device, a compact flash device, a FireWire device, or a smart card device.

14. The system of claim 12, wherein the user data includes executable code for an operating system.

15. The system of claim 12, wherein the user data includes executable code for one or more applications.

16. A method for booting a target computing system from a boot device connected to the target computing system, the method comprising:
verifying the trustworthiness of the target computing system; and
only after the trustworthiness of the target computing system has been verified, loading user data onto the target computing system,
wherein verifying the trustworthiness of the target computing system includes:
establishing communication between the target computing system and a third party system;
proving the trustworthiness of the target computing system to the third party system.

17. The method of claim 16, wherein the target computing system is a TCPA (Trusted Computing Platform Alliance)—enabled system.
